(19) United States
(12) Patent Application Publication
(10) Pub. No.: US 2014/0115513 A1
(43) Pub. Date: Apr. 24, 2014

(54) IMPLEMENTATION METHOD AND APPARATUS FOR PERFORMING MOVE OPERATION ON AREA IN TABLE

(71) Applicant: Tencent Technology (Shenzhen) Company Limited, Shenzhen (CN)

(72) Inventor: Jiyu TAN, Shenzhen (CN)

(73) Assignee: Tencent Technology (Shenzhen) Company Limited, Shenzhen (CN)

(21) Appl. No.: 14/143,916

(22) Filed: Dec. 30, 2013

Related U.S. Application Data
(63) Continuation of application No. PCT/CN2013/074817, filed on Apr. 26, 2013.

(30) Foreign Application Priority Data
May 30, 2012 (CN) 201210172578.6

(51) Int. Cl. G06F 3/0486; G06F 3/0488

(52) U.S. Cl. CPC G06F 3/0486; G06F 3/0488
USPC 715/769

(57) ABSTRACT

The present invention describes an implementation method and apparatus for performing a move operation on an area in a table. The method includes: receiving touch information output by a selected area, triggering a move track of the selected area, and setting an empty area mapping with the selected area as an area to be filled; receiving depart information output by the selected area, obtaining a target area, if a position of the target area is different from a position of the area to be filled, triggering to move a first intermediate area adjacent to the area to be filled to the area to be filled, and then updating the area to be filled to be an empty area; and repeating until the updated area to be filled is an empty area and triggering to move the selected area to the empty area.

### CROSS-REFERENCE TO RELATED APPLICATIONS

This application is a continuation of International Application No. PCT/CN2013/074817, filed on Apr. 26, 2013, which claims priority to Chinese Patent Application No. 201210172578.6, filed on May 30, 2012, entitled “IMPLEMENTATION METHOD AND APPARATUS FOR PERFORMING MOVE OPERATION ON AREA IN TABLE”, which are incorporated herein by reference in their entirety.

### FIELD OF THE TECHNOLOGY

The present invention relates to computer technologies, and in particular, to an implementation method and apparatus for performing a move operation on an area in a table.

### BACKGROUND OF THE INVENTION

With the development of computer touch technologies, users increasingly want to perform operations on a computer by flexibly touching and using gestures, thereby improving service experience for the users. For example, on an existing computer, a gesture operation may be performed to zoom in or out on a current display screen, and by touching words on a screen, required words may be selected for editing (copy, cut, and the like). However, existing operating system software cannot support a complex operation such as moving, for example, a move operation on an area in a table, such as a row or column in a table. For example, a list control (NSTableView control) on the Apple operating system (Mac OS) developed by Apple Incorporation does not support functions such as free moving of a row or column, and supports only operations such as selecting, inserting, and deleting a table by using mouse and menu.

FIG. 1 is a schematic flowchart of an existing method for moving a row or column in a table. The following description illustrates a method for moving a row in a table. A method for moving a column is the same as the method for moving a row. As shown in FIG. 1, the process includes the following steps.

Step 101: Select a source row to be moved.

In this step, a source row on which an operation is to be performed may be selected by using a mouse, by touching, and the like.

Step 102: After selection is confirmed, select a corresponding operation from a preset operation control.

In this step, after the source row is selected, an operation corresponding to moving may be selected from an operation control displayed in a table window toolbar (NSTableView control).

Step 103: Select a target row and insert a new row in front of the target row by performing an operation on the operation control.

Step 104: Select the inserted new row and select a paste operation from the preset operation control.

Step 105: Delete the source row.

In this step, if a copy operation is performed on the source row, the source row in the original table needs to be deleted so as to implement the moving process. If a cut operation is performed on the source row, an empty row mapping with the source row needs to be deleted in the current table.

According to the above description, for the existing method for moving a row or column in a table, since the NSTableView control does not support dragging a row or column in a table by a user to change a position thereof in the table for updating table data, an operation process for moving the row or column is complicated, a long period of time is required, and moving efficiency is low, which fails to provide a direct and humanized operation mode to a user.

### SUMMARY

In view of this, one aspect of the present invention proposes an implementation method for performing a move operation on an area in a table, thereby simplifying a move operation process and improving moving efficiency.

Another aspect of the present invention proposes an implementation apparatus for performing a move operation on an area in a table, thereby simplifying a move operation process and improving moving efficiency.

Embodiments of the present invention provide an implementation method for performing a move operation on an area in a table, where the method includes:

A. receiving touch information output by a selected area, triggering a move track of the selected area, and setting an empty area mapping with the selected area as an area to be filled;

B. receiving depart information output by the selected area, obtaining an area whose distance to a current position of the selected area satisfies a preset condition, and using the obtained area as a target area; if a position of the target area is different from a position of the area to be filled, then implementing the next step;

C. triggering to move a first intermediate area adjacent to the area to be filled in a direction to the target area to the area to be filled, and then updating the area to be filled to be an empty area mapping with the first intermediate area; and

D. repeating step C until the updated area to be filled is an empty area mapping with the target area, and triggering to move the selected area to the empty area mapping with the target area.

In an implementation method for performing a move operation on an area in a table according to another embodiment of the present invention, an area whose distance to a current position of a selected area satisfies a preset condition is an area whose distance to the current position of the selected area is shortest.

Embodiments of the present invention further provide an apparatus for moving an area in a table, where the apparatus includes a monitoring module, an area move-processing module, and an area moving module, where

the monitoring module is configured to receive touch information output by a selected area, trigger a move track of the selected area, and set an empty area mapping with the selected area as an area to be filled;

the area move-processing module is configured to receive depart information output by the selected area, obtain an area whose distance to a current position of the selected area satisfies a preset condition, use the obtained area as a target area, and if a position of the target area is different from a position of the area to be filled, output trigger information to the area moving module; and

the area moving module is configured to receive the trigger information, trigger to move a first intermediate area adjacent to the area to be filled in a direction to the target area to the area to be filled, and then update the area to be filled to be an empty area mapping with the first intermediate area; repeat the operation until the updated area to be filled is an empty area mapping with the target area, and trigger to move the selected area to the empty area mapping with the target area.

In an apparatus for moving an area in a table according to another embodiment of the present invention, an area whose distance to a current position of a selected area satisfies a preset condition is an area whose distance to the current position of the selected area is shortest.

Embodiments of the present invention further provide a machine readable medium, where an instruction set is stored on the machine readable medium, and when the instruction set is executed, the machine may execute the above implementation method for performing a move operation on an area in a table.

Based on the above technical solution, for the implementation method and apparatus for performing a move operation on an area in a table according to the present invention, after touch information output by a selected area is received, a move track of the selected area is triggered, and an empty area mapping with the selected area is set as an area to be filled; after depart information output by the selected area is received, an area whose distance to a current position of the selected area satisfies a preset condition, preferentially, whose distance is shortest, is obtained, and the obtained area is used as a target area; if a position of the target area is different from a position of the area to be filled, it is triggered to move a first intermediate area adjacent to the area to be filled in a direction to the target area to the area to be filled, and then the area to be filled is updated to be an empty area mapping with the first intermediate area; the operation is repeated until the updated area to be filled is an empty area mapping with the target area, and then it is triggered to move the selected area to the empty area mapping with the target area. Hence, area moving is implemented by dragging, thereby simplifying an operation process and improving moving efficiency.

### BRIEF DESCRIPTION OF THE DRAWINGS

FIG. 1 is a schematic flowchart of an existing method for moving a row or column in a table;

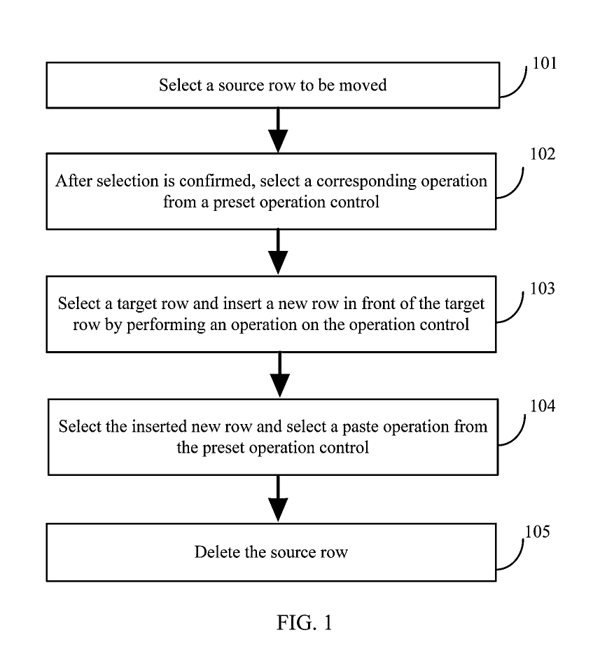

FIG. 2 is a schematic flowchart of an implementation method for performing a move operation on an area in a table according to an embodiment of the present invention;

FIG. 3 is a schematic flowchart of an implementation method for performing a move operation on an area in a table according to a first embodiment of the present invention;

FIG. 4 is a schematic diagram of moving a row within a displayable scope of a table according to the first embodiment of the present invention;

FIG. 5 is a schematic flowchart of an implementation method for performing a move operation on an area in a table according to a second embodiment of the present invention;

FIG. 6 is a schematic diagram of moving a row beyond a displayable scope of a table according to the second embodiment of the present invention;

FIG. 7 is a schematic flowchart of an implementation method for performing a move operation on an area in a table according to a third embodiment of the present invention;

FIG. 8 is a schematic diagram of moving a row in a table within a scope that is not displayed according to the third embodiment of the present invention; and

FIG. 9 is a schematic structural diagram of an implementation apparatus for performing a move operation on an area in a table according to an embodiment of the present invention.

### DETAILED DESCRIPTION OF THE EMBODIMENTS

To make the objective, technical solutions, and advantages of the present invention clearer, the present invention is further described in detail with reference to accompanying drawings and specific embodiments.

In the prior art, when moving an area in a table, operations such as selecting, triggering to pop up an operation control, copying, inserting, pasting, and deleting need to be performed, where the operation process is complicated. In embodiments of the present invention, a customized table control moving technology that support moving is proposed, where a position of an area in a table may be freely changed by dragging the area so as to implement area moving. An operation process is simplified, the operation is intuitive, and user experience may be improved when performing an operation on the table.

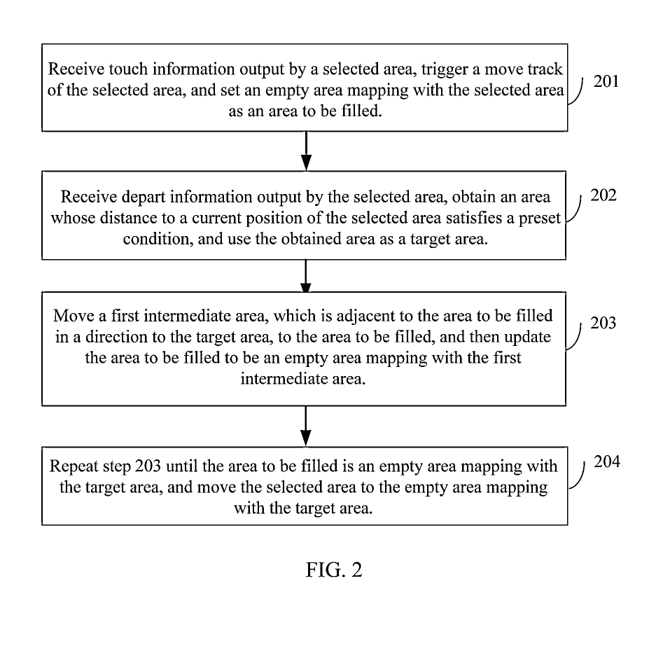

FIG. 2 is a schematic flowchart of an implementation method for performing a move operation on an area in a table according to an embodiment of the present invention. As shown in FIG. 2, the process includes the following steps.

Step 201: Receive touch information output by a selected area, trigger a move track of the selected area, and set an empty area mapping with the selected area as an area to be filled.

In this step, the area may be a row area or a column area in a table, and the row area may include one or more rows. If the area is a row area in a table, correspondingly, the area to be filled is also a row area. A user's operation includes a mouse operation, a touch operation, and the like.

An empty area mapping with an area refers to an area with no content left after an area containing content is moved away. For example, after a row containing data in a table is moved away, a row where the row containing data is located before being moved away becomes an empty row without content, and the empty row is the empty area mapping with the row containing the data, which is equivalent to an empty area left after a cut operation is performed on the area.

In embodiments of the present invention, each area corresponds to an MQView object. The MQView includes data of the area and is responsible for drawing the data of the area in the table, and the drawn data is rendered by drawing the data on a control CALayer which indicates a layer structure and is provided by a system. Reference may be made to relevant technical literature for specific description of the MQView object which will not be described herein.

Before receiving the touch information output by the selected area, the method may include:

determining the selected area according to a monitored first operation.

In this step, when a user needs to perform a move operation on an area, the user selects and confirms an area on which a move operation is to be performed by using a mouse or by touching. For example, when it is monitored that the user presses a left button of a mouse (or a finger starts to touch a table display screen), that is, when it is started to touch the area, a position where the left button of the mouse is pressed (or the finger starts to touch the table display screen) is used as a start point of a selected area; when it is monitored that the user releases the left button of the mouse (or the finger leaves the table display screen), that is, the area is departed, a position where the left button of the mouse is released (or the finger leaves the table display screen; the following description uses the mouse operation as an example) is used as an end point of the selected area, where the selected area is determined as an area containing from the start point to the end point.

In an embodiment, the receiving the touch information output by the selected area may include:

triggering the selected area to output the touch information according to a monitored second operation that is resided on the selected area.

In this step, after the user selects the area, if the left button of the mouse is pressed in the selected area, as long as the left button of the mouse is not released, that is, does not depart the selected area, it indicates that the operation of pressing left button of the mouse is resided on the area, and in a process of dragging by the mouse, the selected area moves with the drag of the mouse. After the area is moved away, a corresponding empty area is left in a position where the area is originally located. The corresponding empty area after the area is moved is set as an area to be filled. That is, a position where the area to be filled is located coincides with a position where the area is located before being moved.

In embodiments of the present invention, the move track of the selected area includes the following modes: the area is moved within a displayable scope of a table, the area is moved beyond a displayable scope of a table, and the area is moved in a table within a scope that is not displayed. Specific process thereof will be described in detail later.

As described above, because each area corresponds to an MQView object, in embodiments of the present invention, a system class CALayer may be invoked to change a position of the MQView on a coordinate axis, thereby realizing a moving effect. For example, a current position of a selected area is y1, and move time is t, then data within the selected area is moved at a constant speed within the time t to an end position y2 of the track. Reference may be made to relevant technical literature for a specific detailed process of invoking the system class CALayer which will not be described herein.

Step 202: Receive depart information output by the selected area, obtain an area whose distance to a current position of the selected area satisfies a preset condition, and use the obtained area as a target area.

In this step, if it is monitored that the user releases the left button of the mouse, that is, departs the selected area, a move operation is triggered so as to complete a process of moving the area.

The area whose distance to the current position of the selected area satisfies the preset condition may be an area whose distance to the current position of the selected area is shortest.

If a position of the target area is the same as a position of the area to be filled, it is triggered to move the selected area to the area to be filled.

If a position of the target area is different from a position of the area to be filled, the following steps are performed.

Step 203: Move a first intermediate area, which is adjacent to the area to be filled in a direction to the target area, to the area to be filled, and then update the area to be filled to be an empty area mapping with the first intermediate area.

Step 204: Repeat step 203 until the area to be filled is an empty area mapping with the target area, and move the selected area to the empty area mapping with the target area. Preferentially, between step 201 and step 202, the method further includes:

obtaining, according to a preset time cycle, an area whose distance to the current position of the selected area satisfies a preset condition, for example, an area with a shortest distance, and using the obtained area as a second intermediate area; and

if a position of the second intermediate area is different from the position of the area to be filled, triggering to move the second intermediate area to the area to be filled, and then updating the area to be filled to be an empty area mapping with the second intermediate area.

In this step, if the position of the second intermediate area is the same as the position of the area to be filled, the step of obtaining, according to a preset time cycle, an area whose distance to the current position of the selected area satisfies a preset condition, for example, an area with a shortest distance, and using the obtained area as a second intermediate area is performed again.

In embodiments of the present invention, a coordinate system is set in the table in advance, and coordinate information about each area in the coordinate system is set according to row spacing of each row.

The set time cycle may be determined according to actual requirements. Position information about the area may be represented by central position information of the area.

The central position information of the area varies as the track moves. Reference may be made to relevant technical literature for specifically how to obtain central position information of an area, which will not be described herein.

In an embodiment, the determining the area with the shortest distance to the current position of the selected area includes:

obtaining a first area where a top border of the selected area in current position is located and a second area which is adjacent to the first area in a direction opposite to a direction in which the selected area is currently moved; and

calculating distances from the central position information of the selected area respectively to central position information of the first area and to central position information of the second area, where an area corresponding to a shortest distance is the area with the shortest distance to the current position of the selected area.

In this step, in a process of moving the selected area, an area corresponding to the top border is the first area, and an area adjacent to the first area in a direction opposite to a direction in which the selected area is moved is the second area. Sizes of the first area and the second area are the same as a size of the selected area. In an actual application, if a selected area is one row or one column, an area covering one part of the selected area is a first area, and an area covering another part of the selected area is the second area.

After the first area and the second area are determined, central position information of the first area and central position information of the second area is obtained. Assume that a table includes four rows and row spacing of each row is 2, if central position information of a row 1 is (1, 2), central position information of a row 2 to a row 4 is respectively (1, 0), (1, −2), and (1, −4). Because horizontal position information of each row is the same, in a calculation, an influence of the horizontal position information of the rows may be ignored.

If the row 3 is to be moved, assume that central position information that is obtained in real time is (3, 0.5), according to the above central position information of the four rows, it may be determined that the central position information is between the row 1 and the row 2. Then, central position information of a first area close to the central position information is (1, 2), and central position information of a second area is (1, 0).

In this embodiment, through the calculation, the second area (the row 2) is closest to a central position of the selected area, then subsequent steps are performed by using the second area (the row 2) as the second intermediate area. Then, it is triggered to move the row 2 to an original position of the row 3, and the original row 2 becomes an empty row, the area to be filled is updated to be the row 2, and then a next step is performed.

If the second intermediate area is the same as a second intermediate area determined last time, no operation is performed, and a next step is performed.

In embodiments of the present invention, receiving touch information and depart information is monitored. If touch information output by a selected area is received, a move track of the selected area is triggered, and an empty area mapping with the selected area is set as an area to be filled. If depart information output by a selected area is received, an area with a shortest distance to a current position of the selected area is obtained; the area with the shortest distance, as well as an area between the area with the shortest distance and an initial moving position of the selected area, are moved by a distance same as the size of the selected area in a direction opposite to a direction in which the selected area is moved, and the selected area is moved to the area with the shortest distance to the current position of the selected area. Before departing the selected area, a real-time move operation of an area may further be implemented according to a preset time cycle.

The present invention is further described in detail by using several specific embodiments.

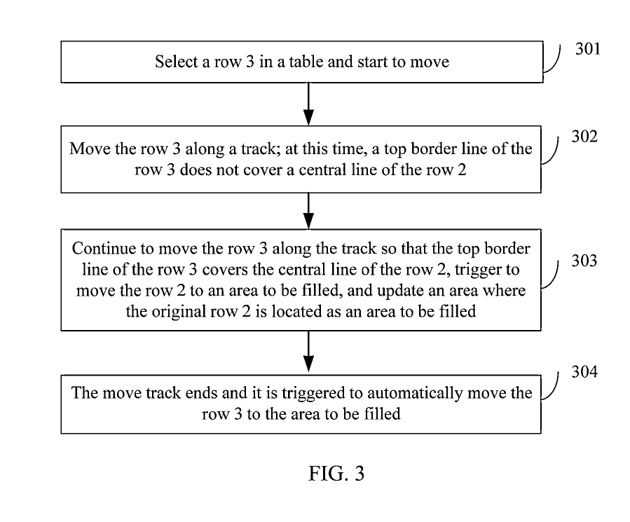

FIG. 3 is a schematic flowchart of an implementation method for performing a move operation on an area in a table according to a first embodiment of the present invention. In this embodiment, a table includes four rows, a row 3 (area) needs to be moved to a row 2, and the area is moved within a displayable scope of the table. As shown in FIG. 3, the process includes the following steps.

Step 301: Select the row 3 in the table and start to move.

In this step, the row 3 is a selected area; an empty row corresponding to an area where the row 3 is originally located, that is, an empty row left after the row 3 is moved, is referred to as an area to be filled; and the row 3 is used as an initial area.

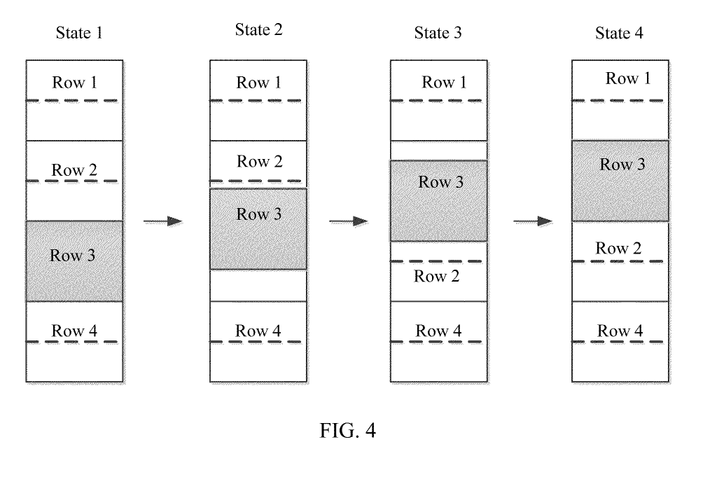

FIG. 4 is a schematic diagram of moving a row within a displayable scope of a table according to the first embodiment of the present invention. A state 1 in FIG. 4 may be referenced when moving is started.

Step 302: Move the row 3 along a track. At this time, a top border line of the row 3 does not cover a central line of the row 2.

In this step, the top border line of the selected area does not cover the central line (which is indicated by a dashed line in the figure) of the row 2, indicating that an area with a shortest distance to central position information of the selected area is still the row 3, where the intermediate area is the same as the area with the shortest distance obtained last time. In such cases, a user does not release a mouse and a step 303 is performed next, as shown in a state 2 in FIG. 4. If the user releases the mouse at this time, a step 304 is performed.

Step 303: Continue to move the row 3 along the track so that the top border line of the row 3 covers the central line of the row 2, trigger to move the row 2 to the area to be filled, and update the area to be filled as an area where the original row 2 is located.

In this step, when the top border line of the selected area covers the central line of the row 2, indicating that an area with a shortest distance to the central position information of the selected area is the row 2, where the area with the shortest distance to the selected area is different from the area with the shortest distance to the selected area obtained last time (the row 3), it is triggered to move the area with the shortest distance to the selected area to the area to be filled, and the area to be filled is updated as a position where the area with the shortest distance to the selected area is located, as shown in a state 3 in FIG. 4.

In embodiments of the present invention, a fill operation is similar to an existing delete or move operation in a table. When an empty area mapping with a selected area is set as an area to be filled, and when the selected area is moved by performing a drag operation to cover a central line of an adjacent area, the area to be filled is immediately filled by the adjacent area, which may provide good experience to a user.

Step 304: The move track ends and it is triggered to automatically move the row 3 to the area to be filled.

In this step, the move track ends, that is, depart information output by the selected area is received; the top border line of the selected area covers the central line of the row 2, indicating that an area with a shortest distance to central position information of the selected area is still the row 2, where the intermediate area is the same as the area with the shortest distance obtained last time (in step 303), and the user releases the mouse at this time, thereby departing the selected area, it is triggered to move the selected area to the updated area to be filled, that is, the row 2, and then the process is ended, as shown in a state 4 in FIG. 4.

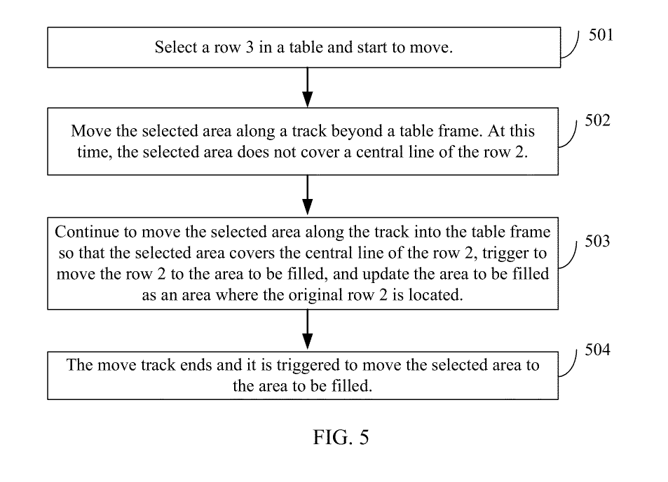

FIG. 5 is a schematic flowchart of an implementation method for performing a move operation on an area in a table according to a second embodiment of the present invention. In this embodiment, a table includes four rows, a row 3 (area) needs to be moved to row 2 (area), and the area is moved beyond a displayable scope of the table. As shown in FIG. 5, the process includes the following steps.

Step 501: Select the row 3 in the table and start to move.

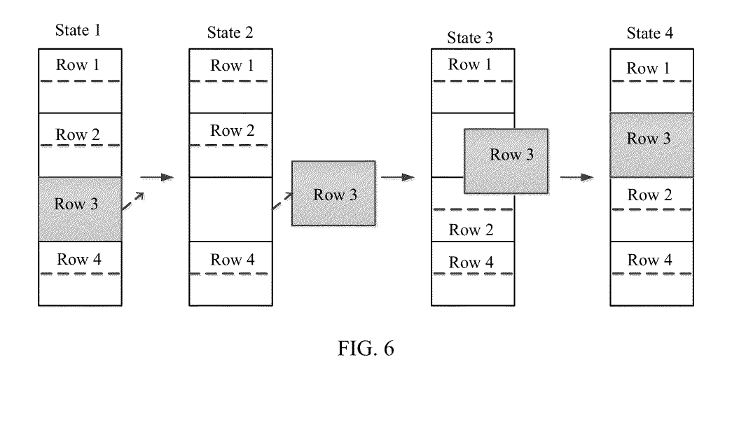

FIG. 6 is a schematic diagram of moving a row beyond a displayable scope of a table according to the second embodiment of the present invention. A state 1 in FIG. 6 may be referenced when moving is started.

Step 502: Move the selected area along a track beyond a table frame. At this time, the selected area does not cover a central line of the row 2.

In this step, a state 2 in FIG. 6 may be referenced for moving of the selected area.

Step 503: Continue to move the selected area along the track into the table frame so that the selected area covers the central line of the row 2, trigger to move the row 2 to the area to be filled, and update the area to be filled as an area where the original row 2 is located.

In this step, a state 3 in FIG. 6 may be referenced for moving of the selected area.

Step 504: The move track ends and it is triggered to move the selected area to the area to be filled.

In this step, a state 4 in FIG. 6 may be referenced for moving of the selected area.

In an actual application, some table frames has data on more than 1 page and some rows are located in an invisible scope, that is, the rows are hidden, and a process for moving a row to a position that is not displayed is as follows.

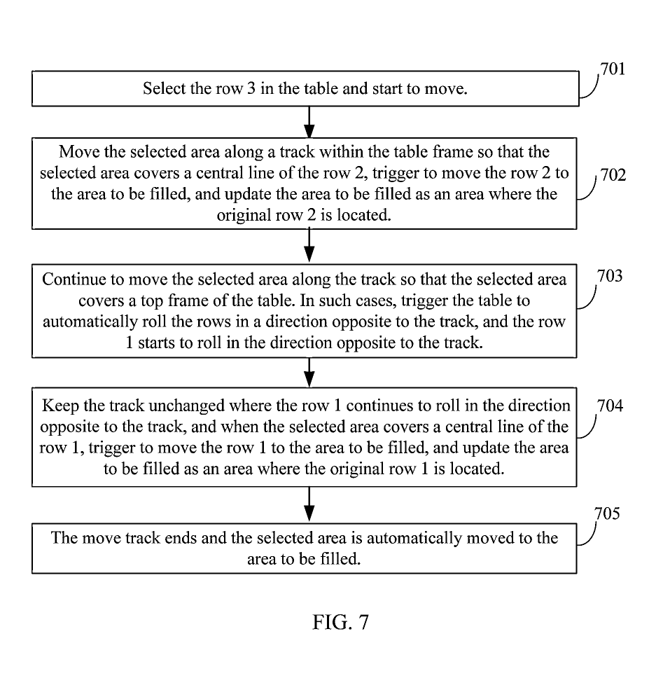

FIG. 7 is a schematic flowchart of an implementation method for performing a move operation on an area in a table according to a third embodiment of the present invention. In this embodiment, a table includes four rows, a row 3 (selected area) needs to be moved to a row 1 (area), and the selected area is moved in the table within a scope that is not displayed. As shown in FIG. 7, the process includes the following steps.

Step 701: Select the row 3 in the table and start to move.

In this step, assume that a table frame has four rows in total; however, only three rows are displayable, and the row 1 is located in an area not displayed.

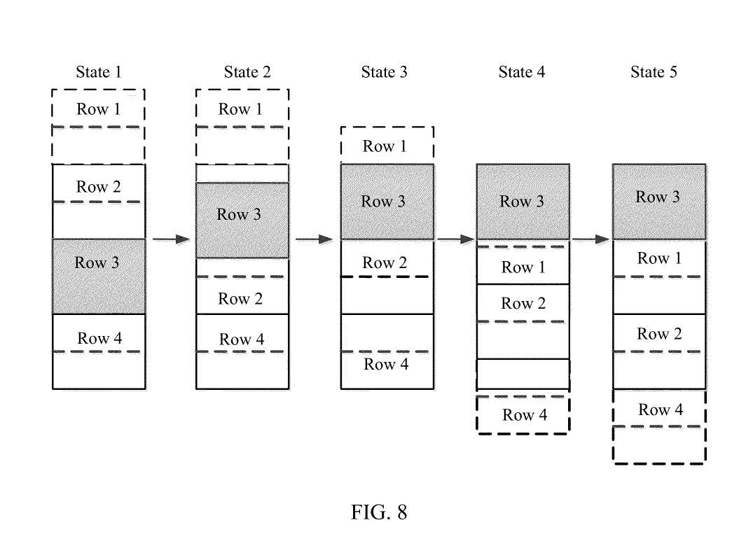

FIG. 8 is a schematic diagram of moving a row in a table within a scope that is not displayed according to the third embodiment of the present invention. A row located in an area that cannot be displayed is represented by a row located in a dashed line frame. Reference may be made to a state 1 in FIG. 8 when moving is started.

Step 702: Move the selected area along a track within the table frame so that the selected area covers a central line of the row 2, trigger to move the row 2 to the area to be filled, and update the area to be filled as an area where the original row 2 is located.

In this step, a state 2 in FIG. 8 may be referenced for moving of the selected area.

Step 703: Continue to move the selected area along the track so that the selected area covers a top frame of the table. In such cases, trigger the table to automatically roll the rows in a direction opposite to the track, and the row 1 starts to roll in the direction opposite to the track.

In this step, a state 3 in FIG. 8 may be referenced for moving of the selected area.

Step 704: Keep the track unchanged where the row 1 continues to roll in the direction opposite to the track, and when the selected area covers a central line of the row 1, trigger to move the row 1 to the area to be filled, and update the area to be filled as an area where the original row 1 is located.

In this step, a state 4 in FIG. 8 may be referenced for moving of the selected area.

Step 705: The move track ends and the selected area is automatically moved to the area to be filled.

In this step, a state 5 in FIG. 8 may be referenced for moving of the selected area.

According to the above description, in an implementation method for performing a move operation on an area in a table according to embodiments of the present invention, after an area to be moved is selected, an operation is resided on the selected area; an area move track is triggered; and an empty area mapping with the selected area is set as an area to be filled; after the selected area covers more than a half of an area, it is triggered to move the covered area to the area to be filled and update the area to be filled as an empty area mapping with the covered area; when it is monitored that the selected area is departed, it is triggered to move the selected area to the updated area to be filled. Hence, moving an area is implemented by dragging, which simplifies an operation process, reduces time required for the moving, improves moving efficiency, and may provide a direct and humanized operation mode to a user, thereby greatly improving operation experience of the user.

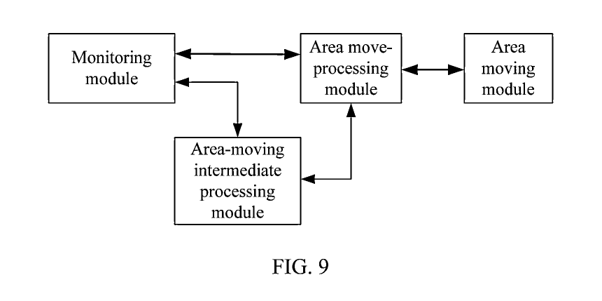

FIG. 9 is a schematic structural diagram of an implementation apparatus for performing a move operation on an area in a table according to an embodiment of the present invention. As shown in FIG. 9, the apparatus includes a monitoring module, an area move-processing module, and an area moving module, where

the monitoring module is configured to receive touch information output by a selected area, trigger a move track of the selected area, and set an empty area mapping with the selected area as an area to be filled;

the area move-processing module is configured to receive depart information output by the selected area, obtain an area whose distance to a current position of the selected area satisfies a preset condition, for example, an area with a shortest distance, use the obtained area as a target area, and if a position of the target area is different from a position of the area to be filled, output trigger information to the area moving module; and

the area moving module is configured to receive the trigger information, trigger to move a first intermediate area adjacent to the area to be filled in a direction to the target area to the area to be filled, and then update the area to be filled to be an empty area mapping with the first intermediate area; repeat the operation until the updated area to be filled is an empty area mapping with the target area, and trigger to move the selected area to the empty area mapping with the target area.

The apparatus may further include:

an area-moving intermediate processing module, configured to obtain, after the touch information output the selected area is received and before the depart information output by the selected area is received, an area whose distance to the current position of the selected area satisfies a preset condition, for example, an area with a shortest distance, according to a preset time cycle, and use the area as a second intermediate area; if a position of the second intermediate area is different from a position of the area to be filled, trigger to move the second intermediate area to the area to be filled, and then update the area to be filled to be an empty area mapping with the second intermediate area.

Preferentially, the area-moving intermediate processing module includes an area position information obtaining unit, an area obtaining unit, an area matching unit, and an area processing unit (not shown in the figure), where

the area position information obtaining unit is configured to obtain position information of an moved area according to a preset time cycle;

the area obtaining unit is configured to obtain an area with a shortest distance to the position information in the area position information obtaining unit according to preset position information of areas, and use the determined area as the second intermediate area;

the area matching unit is configured to determine whether the second intermediate area is the same as the area to be filled; if no, output trigger information to the area processing unit; and if yes, output notification information to the area position information obtaining unit, so that the area position information obtaining unit executes a periodical obtaining process; and

the area processing unit is configured to receive the trigger information, move the second intermediate area to the area to be filled, and then update the area to be filled to be an empty area mapping with the second intermediate area.

The method according to the present invention may be stored as a computer program in a machine readable medium, such as a CD-ROM. The processor is configured to execute instructions stored in the machine readable medium, and is configured to execute the various embodiments of the implementation method for performing a move operation on an area in a table.

The above are merely preferred embodiments of the present invention. However, the scope of the present invention is not limited thereto. All modifications, equivalent replacements, and improvements made without departing from the spirit and principle of the present invention shall fall within the scope of the present invention.

1. An implementation method for performing a move operation on an area in a table, wherein the table is displayed on a touch sensitive screen of a computing device, the method comprising:
receiving touch information output by a selected area, triggering a move track of the selected area, and setting an empty area mapping with the selected area as an area to be filled;
receiving depart information output by the selected area, obtaining an area whose distance to a current position of the selected area satisfies a preset condition, and using the obtained area whose distance satisfies the preset condition as a target area; and if a position of the target area is different from a position of the area to be filled, then
triggering to move a first intermediate area adjacent to the area to be filled in a direction to the target area to the area to be filled, and then updating the area to be filled to be an empty area mapping with the first intermediate area until the updated area to be filled is an empty area mapping with the target area, and triggering to move the selected area to the empty area mapping with the target area.

2. The method according to claim 1, wherein in response to receiving touch information, the method further comprises:
according to a preset time cycle, obtaining an area whose distance to the current position of the selected area satisfies a preset condition, and using the area whose distance satisfies the preset condition as a second intermediate area; and
if a position of the second intermediate area is different from the position of the area to be filled, triggering to move the second intermediate area to the area to be filled, and then updating the area to be filled to be an empty area mapping with the second intermediate area.

3. The method according to claim 2, wherein in response to determining that the position of the second intermediate area is same as the position of the area to be filled, the method further comprising:
according to a preset time cycle, obtaining an area whose distance to the current position of the selected area satisfies a preset condition, and using the area whose distance satisfies the preset condition as a second intermediate area.

4. The method according to claim 1, further comprising:
if the position of the target area is the same as the position of the area to be filled, triggering to move the selected area to the area to be filled.

5. The method according to claim 1, wherein before receiving the touch information output by the selected area, the method further comprises:
determining the selected area according to a monitored first operation.

6. The method according to claim 1, wherein the receiving the touch information output by the selected area comprises:
triggering the selected area to output the touch information according to a monitored second operation that is resided on the selected area.

7. The method according to claim 5, wherein the determining the selected area according to a monitored first operation comprises:
monitoring starting of touching an area, and using a position where the touching is started as a start point of the selected area;
monitoring departing the area, and using a position where the area is departed as an end point of the selected area; and
determining the selected area as an area containing from the start point to the end point.

8. The method according to claim 1, wherein the present condition is the distance being shortest.

9. The method according to claim 8, wherein the positions are central positions of areas, and the obtaining the area whose distance to the current position of the selected area satisfies a preset condition comprises:
obtaining a first area where a top border of the selected area in the current position is located and a second area adjacent to the first area in a direction opposite to a direction in which the selected area is currently moved; and
calculating distances from the central position information of the selected area respectively to central position information of the first area and to central position information of the second area, wherein an area corresponding to a shortest distance is the area with a shortest distance to the current position of the selected area.

10. An apparatus for moving an area in a table, wherein the apparatus comprises a monitoring module, an area move-processing module, and an area moving module, wherein
the monitoring module is configured to receive touch information output by a selected area, trigger a move track of the selected area, and set an empty area mapping with the selected area as an area to be filled;
the area move-processing module is configured to receive depart information output by the selected area, obtain an area whose distance to a current position of the selected area satisfies a preset condition, use the obtained area as a target area, and if a position of the target area is different from a position of the area to be filled, output trigger information to the area moving module; and
the area moving module is configured to receive the trigger information, trigger to move a first intermediate area adjacent to the area to be filled in a direction to the target area to the area to be filled, and then update the area to be filled to be an empty area mapping with the first intermediate area; repeat the operation until the updated area to be filled is an empty area mapping with the target area, and trigger to move the selected area to the empty area mapping with the target area.

11. The apparatus according to claim 10, further comprising:
an area-moving intermediate processing module, configured to obtain, after the touch information output the selected area is received and before the depart information output by the selected area is received, an area whose distance to the current position of the selected area satisfies a preset condition according to a preset time cycle, and use the area as a second intermediate area; if a position of the second intermediate area is different from a position of the area to be filled, trigger to move the second intermediate area to the area to be filled, and then update the area to be filled to be an empty area mapping with the second intermediate area.

12. The apparatus according to claim 11, wherein the present condition is the distance being shortest.

13. The apparatus according to claim 12, wherein the area-moving intermediate processing module comprises an area position information obtaining unit, an area obtaining unit, an area matching unit, and an area processing unit, wherein
the area position information obtaining unit is configured to obtain position information of an moved area according to a preset time cycle;
the area obtaining unit is configured to obtain an area with a shortest distance to the position information in the area position information obtaining unit according to preset position information of areas, and use the obtained area as the second intermediate area;
the area matching unit is configured to determine whether the second intermediate area is the same as the area to be filled; if no, output trigger information to the area processing unit; and if yes, output notification information to the area position information obtaining unit, so that the area position information obtaining unit executes a periodical obtaining process; and
the area processing unit is configured to receive the trigger information, move the second intermediate area to the area to be filled, and then update the area to be filled to be an empty area mapping with the second intermediate area.

14. A non-transitory machine readable medium, wherein an instruction set is stored therein, and when the instruction set is executed, a machine executes an implementation method for performing a move operation on an area in a table, wherein the implementation method comprises:
receiving touch information output by a selected area, triggering a move track of the selected area, and setting an empty area mapping with the selected area as an area to be filled;
receiving depart information output by the selected area, obtaining an area whose distance to a current position of the selected area satisfies a preset condition, and using the obtained area whose distance satisfies the preset condition as a target area; and if a position of the target area is different from a position of the area to be filled, then
triggering to move a first intermediate area adjacent to the area to be filled in a direction to the target area to the area to be filled, and then updating the area to be filled to be an empty area mapping with the first intermediate area until the updated area to be filled is an empty area mapping with the target area; and
triggering to move the selected area to the empty area mapping with the target area.
